(19) United States
(12) Patent Application Publication
(10) Pub. No.: US 2024/0138630 A1
(43) Pub. Date: May 2, 2024

(54) FOOD PROCESSOR AND METHOD

(71) Applicant: Vorwerk & Co. Interholding GmbH, Wuppertal (DE)

(72) Inventors: Kevin Schmitz, Haan (DE); Sebastian Jansen, Bochum (DE); Felix Haunschild, Essen (DE)

(21) Appl. No.: 18/499,708

(22) Filed: Nov. 1, 2023

(30) Foreign Application Priority Data
Nov. 2, 2022 (DE) 22205063.5

(51) Int. Cl. A47J 44/00; A47J 43/07

(52) U.S. Cl. CPC A47J 44/00; A47J 43/0716

(57) ABSTRACT

The present disclosure relates to a food processor for performing a food preparation process by heating, chopping and/or stirring a food in a food preparation vessel by means of a heating element for heating and/or a rotatable tool for chopping and/or stirring the food in the food preparation vessel, wherein the food processor comprises at least one functional unit including a motor for rotating the tool and/or the heating element for heating, wherein the food processor comprises at least one device for limiting a degree of freedom of a user during use of the food processor for food preparation including at least one motor-driven locking device for the food preparation vessel or its lid. A control of the food processor is configured such that, based on a plurality of parameters that are able to describe or influence the food preparation process, the control controls the at least one functional unit and the at least one device for limiting a degree of freedom such that a reduction or increase in the user's degree of freedom during use of the food processor can be effected in dependence on the plurality of parameters. The disclosure further relates to a corresponding method and computer program. The degree of freedom of the user can thereby be increased in an improved manner during the preparation of a food with a food processor.

### PRIORITY CLAIM

This application claims priority to European Application Serial No. 22205063.5 filed Nov. 11, 2022, which is expressly incorporated by reference herein.

### FIELD OF THE DISCLOSURE

The present disclosure relates to a food processor for performing a food preparation process by heating, chopping and/or stirring a food in a food preparation vessel.

### BACKGROUND

A food processor supports the user with helpful functions when preparing a food. However, supporting functions of a food processor are usually accompanied by limitations of the degree of freedom for the user during food preparation.

It is the task of the disclosure to provide an improved food processor together with a method and a computer program.

### SUMMARY

The present disclosure teaches a food processor for performing a food preparation process by heating, chopping and/or stirring a food in a food preparation vessel by means of a heating element for heating and/or a rotatable tool for chopping and/or stirring the food in the food preparation vessel. The food processor comprises at least one functional unit including a motor for rotating the tool and/or the heating element for heating. The food processor comprises at least one device for limiting a degree of freedom of a user during use of the food processor for food preparation including at least one motor-driven locking device for the food preparation vessel or its lid. A control of the food processor is configured such that, based on a plurality of parameters that are able to describe or influence the food preparation process, the control controls the at least one functional unit and the at least one device for limiting a degree of freedom such that a reduction or increase in the degree of freedom of the user during use of the food processor can be effected in dependence on the plurality of parameters.

In this way, the degree of freedom can be increased or even maximized while maintaining, at the same time, the usual cooking comfort for the user when cooking with a food processor.

### BRIEF DESCRIPTIONS OF THE DRAWINGS

The figures show:

FIG. 1: Schematic representation of a food processor with a partial section through the food preparation vessel;

FIG. 2: Schematic flow chart for reducing or increasing the degree of freedom of the user during the use of the food processor depending on a plurality of parameters;

FIG. 3a: Exemplary illustration regarding the reduction or increase of the degree of freedom of the user during use of the food processor when the lid is in the closed position;

FIG. 3a: Exemplary illustration related to the reduction or increase of the degree of freedom of the user during the use of the food processor when the lid is not in the closed position.

### DETAILED DESCRIPTION

In the following, exemplary embodiments of the present disclosure will be explained in more detail with reference to figures. Features of the exemplary embodiments may be combined individually or in a plurality with the claimed subject matter, unless otherwise indicated. The claimed areas of protection are not limited to the exemplary embodiments.

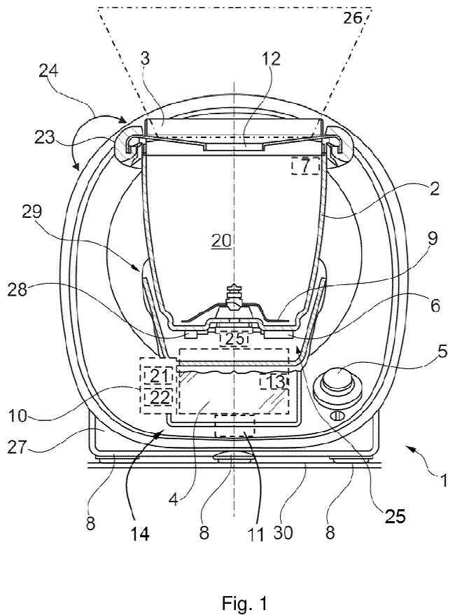

FIG. 1 shows a food processor 1 for performing a food preparation process in a food preparation vessel 2. A heating element 6 may be provided for heating the food 20, in particular in the bottom region of the food preparation vessel 2. A rotatable tool 9 may be inserted for chopping and/or stirring the food 20, which is coupled to a motor 11 via a shaft not shown, in particular through an opening in the bottom of the food preparation vessel 2. A housing 27 of the food processor encloses the motor 11 and provides a receptacle 29 for the food preparation vessel 2. In the simplest case, the receptacle 29 may be a surface on the upper side of the housing 27 that is adapted to the underside of the food preparation vessel 2 and may be substantially flat. In particular, one or more weight sensors 8 are provided preferably in the feet of the food processor 1 through which the housing 27 rests on a base 30. The food processor 1 has a control 10 for controlling the functional component such as heating element 6 or tool 9 and/or motor 11. Measurement sensors for detecting an actual state such as a temperature sensor 28 are preferably provided. The control 10 comprises or is operated by at least one processor 21 and at least one memory 22. The control 10 may be partially outsourced to a cloud, wherein at least one processor and at least one memory of the control 10 are then located on a cloud server, preferably on a cloud server of an external data center. In one embodiment, a smartphone of a user may be the cloud server or may constitute or operate a part of the control.

A lid 3 may be provided to close the food preparation vessel 2. The lid 3 may include a lid opening 12 for dispensing ingredients into the food preparation vessel 2 that is predominantly covered by the lid 3. A motor-driven locking device 23 for the lid 3, i.e. for locking the lid 3 to the food preparation vessel 2, is provided. By means of movable locking means of the locking device 23, the lid 3 on the upper side of the food preparation vessel 2 can be brought into a locked state or released state. Furthermore, a motor-driven locking device 25 is provided for the food preparation vessel 2, i.e., for locking the food preparation vessel 2 to the receptacle 29 of the housing 27 of the food processor 1. The locking device 23 for the lid 3 is configured such that a locking movement 24 relative to the lid 3 and/or food preparation vessel 2 either locks, i.e., changes from the unlocked state to the locked state, or unlocks, i.e., changes from the locked state to the unlocked state. The locking movement 24 is driven by means of a motor not shown. In particular, the locking device 23 for the lid 3 and the locking device 25 for the food preparation vessel 2 form a common, coupled locking device 23, 25, so that the lid 3 can be coupled and/or unlocked with the food preparation vessel 2, and the food preparation vessel 2 can be locked and/or unlocked with the receptacle 29 together simultaneously or with a time delay. The locked or unlocked state of the lid 3 can be detected, for example, by a lid locking sensor not shown. The locked or unlocked state of the food preparation vessel 2 at the bottom side of the food preparation vessel 2 with the receptacle 29 can be detected, for example, by a vessel locking sensor not shown. Furthermore, a closing-position sensor 7 not shown is provided in particular, which can detect whether the lid 3 rests on the food preparation vessel 2 in a closed position, by which the food preparation vessel 2 is covered from above by the lid 3 in a predefined manner.

Optionally, an accessory 26 can be attached to the lid 3, for example in the form of a container attachment for placement on the lid 3, in particular with openings on the underside for admitting steam from the food preparation vessel 2 into the container attachment. In a further embodiment, the accessory 26 attached to the lid 3 can be mechanically coupled to the tool 9 from above in a rotationally fixed manner in at least one rotational direction.

In one embodiment, the food processor 1 is configured such that attaching an accessory 26 to the lid 3 causes the locking device 23 to be activated for locking.

The user may receive information and instructions from the control 10 and provide input to the control 10A via user interface, particularly comprising a touchscreen display 4, at least one button, and/or voice recognition not shown. Such input may comprise a desired value for the at least one functional unit. An input may also be a recipe selection. Preferably, the user may cook in a manual cooking mode or in a recipe-assisted cooking mode that the user. The knob may be a rotary knob 5 and/or an icon 13 on the touchscreen display 4. In particular, the voice recognition unit comprises a microphone. In one embodiment, the voice recognition unit is outsourced to the user's smartphone and/or is part of the control 10. In particular, the indication is output to the user via an output unit 14, which preferably comprises the display 4 for an indication in text form, a speaker not shown for output in acoustic form, and/or a light means not shown for output in the form of a light-up.

In particular, the control 10 has access to digital recipes with multiple recipe steps that can be performed by means of the aforementioned user interface by the user and the food processor 1 to prepare a food 20. A recipe step includes desired values for the at least one functional unit to appropriately control the functional unit(s) to implement the planned food preparation process or cooking process.

Based on one or more cooking parameters in the form of desired values for controlling the heating element 6 and the motor 11 for the tool 9, the control 10 ensures that a food 20 is heated, chopped and/or mixed in the food preparation vessel 2 in a desired manner.

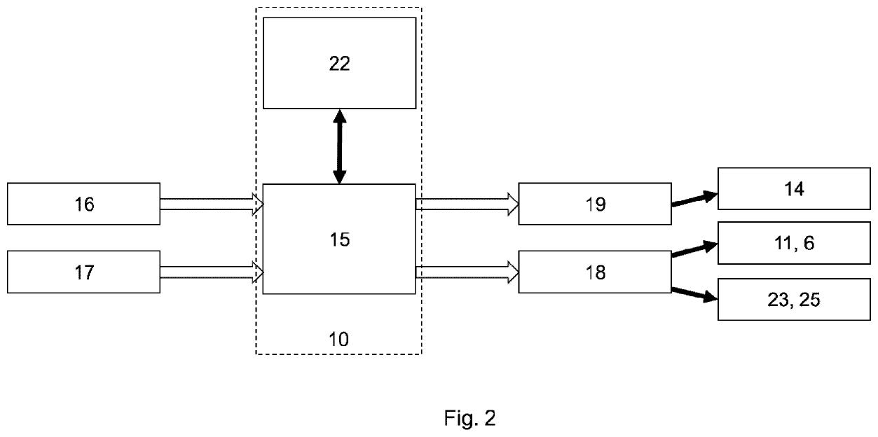

FIG. 2 shows a schematic flowchart for reducing or increasing the degree of freedom of the user during use of the food processor depending on a plurality of parameters. A first input variable 16 is in particular a requested or planned change, if any. A second input variable 17 comprises the plurality of parameters, which in particular comprise actual states. The checking unit 15 of the control 10 checks the input variables 16, 17 while accessing the memory 22 with the stored data, which comprise in particular at least one predefined criterion, a decision tree and/or a decision matrix. Depending on the result of the check (“permitted” or “not permitted” and/or “tolerated” or “not tolerated”), an action 18 also determined by means of the stored data of memory 22 and/or an indication 19 determined by means of the stored data of memory 22 is implemented by the control. An indication 19 is output to the user via the output unit 14. A measure 18 is implemented by controlling the at least one functional unit and/or the at least one device. The device is in particular a locking device, preferably the locking device 23, 25 for the lid and/or the food preparation vessel. The functional unit is in particular the heating element 6 and/or the motor 11 for the tool 9.

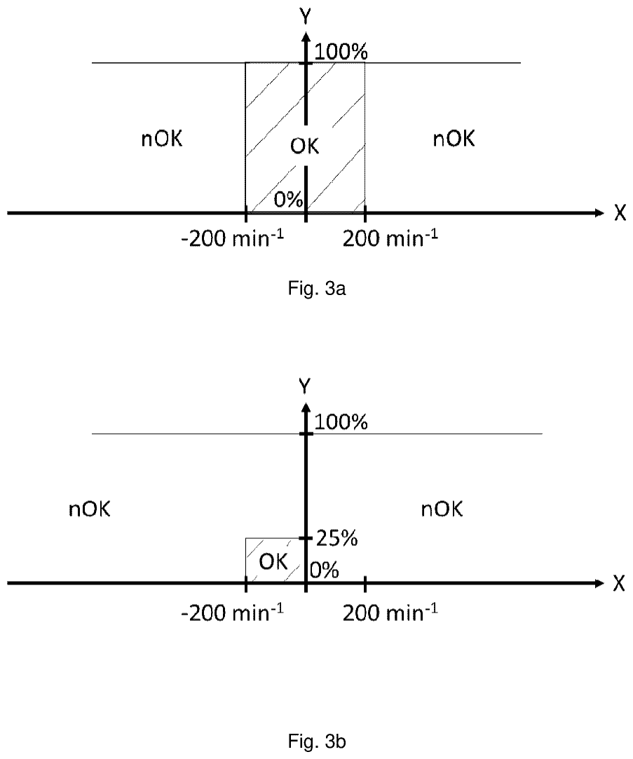

In FIGS. 3a and 3b, the rotational speed of the tool 9 is plotted on the X axis in revolutions per minute (rpm), abbreviated min⁻¹. Values >0 mean clockwise rotation, i.e. revolutions per minute in a direction of rotation to the right. Values <0 mean counterclockwise rotation, i.e. revolutions per minute in a direction of rotation to the left. In FIGS. 3a and 3b, the Y-axis describes the proportion in [%] of the actual torque to the maximum possible torque. FIGS. 3a and 3b are explained in more detail below.

FIG. 3a exemplarily illustrates an excerpt from a decision tree or decision matrix for checking the reduction or increase of the user's degree of freedom in particular by the checking unit 15 during the use of the food processor 1, when the lid 3 is in the closed position and the locking device 23 for the lid 3 is in the unlocked position. “nOK” in FIG. 3a means “not permitted” or “not tolerated”, and “OK” correspondingly means “permitted” or “tolerated”. If a requested change e.g. of the user occurs after an increase of the rotational speed from 0 rpm to 400 rpm, the check would show that in this situation this increase is not permitted. The control will then not change the rotational speed or change the rotational speed in a modified manner to 200 rpm, because 200 rpm is the maximum permitted rotational speed that is closest to the requested rotational speed. And if during the food preparation process, at an actual rotational speed of 100 rpm, the actual torque to maximum torque suddenly increases from 50% to 80% of the maximum torque, the check would indicate that this change can be tolerated and no action needs to be taken.

FIG. 3b illustrates an example of an excerpt from a decision tree or decision matrix for checking the reduction or increase of the user's degree of freedom, in particular by the checking unit 15, during use of the food processor 1 when the lid 3 is not in the closed position and the locking device 23 for the lid 3 is in the unlocked position. “nOK” in FIG. 3a means “not permitted” or “not tolerated”, and “OK” correspondingly means “permitted” or “tolerated”. If, for example, the user removes the cover 3 at a rotational speed of −100 rpm (i.e. in counterclockwise rotation) and a torque ratio of 20%, the check will evaluate this change as tolerable and the control will not take any action. However, if the user now requests a change (by pressing an appropriate button on the food processor) to change the direction of rotation from counterclockwise (rotating the tool with a blunt edge in the direction of rotation) to clockwise (cutting direction), the check will evaluate this requested change as not permissible and the control 10 will not change the direction of rotation. Instead, the control 10 will issue an indication to the user via the output unit 14 that to change the direction of rotation, the lid 3 must be brought to the closed position.

In a further embodiment, not shown in the figures, the following is stored in the stored data to define a decision tree or decision matrix for the check of reducing or increasing the user's degree of freedom. The following rotational speed specifications refer to an outer contour of the tool 9 or the radially outermost point of the tool 9. In particular, the following rotational speed specifications are absolute values, i.e. always 0, so that rotational speed >0 may capture both counterclockwise rotation and clockwise rotation:

In a rotational speed range with a lower limit of preferably about 200 rpm, the lid must be locked to the food preparation vessel, regardless of the actual temperature. For example, unlocking of the lid in this rotational speed range is therefore not permitted and is also not tolerated. If the mentioned rotational speed range is left downwards, i.e. at rotational speeds lower than about 200 rpm, a result of a check taking into account further input variables may include that unlocking and removal of the lid can be permitted and tolerated.

In a temperature range with an upper temperature limit of the actual temperature up to about 95° C., an unlocking and removal of the lid from the food preparation vessel can be permitted at a rotational speed greater than 0 rpm and less than about 200 rpm, if immediately after the removal of the lid the rotational speed has been reduced to 0 rpm (by an appropriate action of the control). Heating with the heating element can then be freely continued within this temperature range, even with the lid open, and the desired temperature can be freely changed within the said temperature range.

In a temperature range with an upper temperature limit of the actual temperature up to approximately 95° C. and a rotational speed of 0 rpm, it is permitted and tolerated by the stored data within the check to leave the lid in the unlocked state at all actual and desired temperatures in this range, to unlock the lid, to remove the lid and to leave the food preparation vessel open (i.e. not covered by the lid) during food preparation in the said parameter range of rotational speed (=0 rpm) and temperature 95° C.).

In a temperature range of greater than about 95° C. and less than about 130° C. in conjunction with a rotational speed range between 0 rpm and about 200 rpm, it is permitted and tolerated by the stored data within the check to unlock and remove the lid if the control limits as a measure a continuation of heating by the heating element to a fixed period of time. For example, the fixed time duration may be at least 5 seconds or/and at most 15 seconds.

In a temperature range greater than about 130° C. (and preferably less than about 220° C.) in conjunction with a rotational speed range between 0 rpm and about 200 rpm, it is permitted and tolerated by the stored data within the check to unlock and remove the lid if the control limits as a measure a continuation of heating by the heating element to a fixed time period. For example, the fixed time duration may be at least 3 seconds or/and at most 10 seconds.

In particular, it is provided that the locking device 25 for the food preparation vessel 2 is automatically brought into the unlocked state when the locking device 23 for the lid 3 changes from the locked state to the unlocked state. In particular, it is provided that the locking device 23 for the lid 3 is always automatically brought into the unlocked state when the locking device 25 for the food preparation vessel 2 changes from the locked state to the unlocked state.

Designs in accordance with the present disclosure can include food processor for performing a food preparation process by heating, chopping and/or stirring a food in a food preparation vessel. These various functions can be accomplished by means of a heating element for heating and a rotatable tool for chopping and/or stirring the food in the food preparation vessel. The food processor can comprise at least one functional unit including a motor for rotating the tool and/or the heating element for heating. The food processor can comprise at least one device for limiting a degree of freedom of a user during the use of the food processor for food preparation including at least one motor-driven locking device for the food preparation vessel or its lid.

Features of the present disclosure are informed by the insight that, despite an increase in the degree of freedom for the user, the usual cooking comfort when cooking with a food processor can still be maintained if an increase and a reduction of the user's degree of freedom during the use of the food processor are performed based on a plurality of parameters. An increase or even maximization of the overall degree of freedom can be effected thereby, the technical handling of the food processor can thus be improved and food of higher quality can be obtained. As a positive side effect, cooking with the food processor is as free as possible with fewer restrictions overall.

Particularly in the area of food processors, which increasingly guide and direct the user in order to ensure the most user-independent, reproducible cooking results possible, the degree of freedom for the user was previously usually specifically provided at a fixed, predefined and thus generally lower degree of freedom, which ensured the usual cooking comfort, and which only allowed a greater variety of preparations within these narrow limits. In some food processors, these limits were widened selectively, but rigidly with corresponding switching electronics. The usual cooking comfort of a food processor includes the assumption of partial cooking functions by the food processor such as stirring, chopping and/or heating, optional cooking instruction measures as well as necessary monitoring and safety devices, so that the user can prepare a food comparatively easily and reliably.

For example, the presently disclosed device can achieve that the degree of freedom for the user is automatically increased during the food preparation process with the food processor if a check of the plurality of parameters (of the actual state) evaluates this to be tolerable. This may result in the lid and/or food preparation vessel unlocking without prior notice during the food preparation process. If the user wants to lift the lid or the food preparation vessel during the food preparation process, this is then possible for certain periods of time (because in unlocked position) and not possible in other periods of time of the food preparation process (because in locked position).

For example, the presently disclosed device can achieve that during the food preparation process with the food processor, the user attempts to lift off the lid or attempts to change a desired value for one of the at least one functional unit (such as the rotational speed of the tool or the temperature) via a user interface. While in conventional food processors there are rigid limits to such requested changes by the user, the disclosed device in particular performs a check of the requested change by the user based on the current situation (based on the plurality of parameters) as to whether or not this requested change can be permitted. If the requested change can be permitted considering the plurality of parameters in the current situation, the requested change is implemented. Otherwise, the requested change is either not implemented or implemented in a modified way (i.e., as similar or close as possible to the requested change). For example, if the requested rotational speed is too high to be permitted, the maximum permissible increase in rotational speed under the given circumstances is implemented.

For example, the presently disclosed device can achieve that during the food preparation in a recipe-assisted cooking mode based on a digital recipe with recipe steps, preferably required manual actions of the user are brought forward in the course of the food preparation process planned by the recipe and the user is requested to perform these manual actions already at the beginning of a recipe or a recipe step. This reduces the user's degree of freedom for a longer period of time (because, for example, the user is required to bring the lid to the closed position already at the beginning), but in return gives the user the additional freedom to step away from the food processor for a longer period of time because no manual actions are required from the user for a longer period of time. At the same time, the user can still attempt to change the device state or desired values of a functional unit, wherein such a requested change is then checked and—if permissible—implemented as described above, so that the degree of freedom of the user is also increased overall in this embodiment.

What is permissible or tolerable is defined in particular in stored data in such a way that a usual cooking comfort can always be ensured.

For example, the presently disclosed device can achieve that states of the food or ingredients in the food preparation vessel are also considered in the check by the plurality of parameters as to whether an actual state can be tolerated or a requested change can be permitted, while maintaining a high degree of freedom, for example, by maintaining an unlocked position of one of the at least one locking device. For example, a requested temperature increase may be permissible for highly viscous ingredients, while the same temperature increase for low viscosity ingredients in the food preparation vessel could lead to burning and is therefore not permissible. For example, a requested temperature increase may be permissible for a cooking process planned by a recipe step in the form of a sautéing (frying) process, and not permissible for a cooking process planned by a recipe step in the form of a steaming process. By a consideration of parameters of the plurality of the parameters, which reflect also for example the ingredient conditions and/or a cooking process planned by a recipe step, a higher degree of freedom can be permitted to the user by this more detailed check of the current situation in many cases, which would not be possible with conventional food processors.

The degree of freedom of a user during the use of the food processor may be a measure of the possibilities of the user to influence the food processor and/or the food preparation process. Particularly preferably, the degree of freedom may be described in terms of a number of permitted changes (by the control). In particular, the number of permitted changes comprises the possibility for the user to change a position (e.g., locked position or unlocked position of the lid with the food preparation vessel and/or of the food preparation vessel with the receptacle) of the at least one device. In particular, the number of permitted changes comprises the possibility of changing a device state, preferably a change of the lid position (closed position or not in closed position on the food preparation vessel), a change of the type of the food preparation vessel used (by a removal of a food preparation vessel of a first type and the insertion of a food preparation vessel of a different, second type) and/or a change of the type or the presences of the tool or an accessory (i.e. an accessory part), preferably detectable by means of an accessory recognition. In particular, the number of permitted changes comprises the possibility of changing a desired value of the at least one functional unit, in particular concerning a direction of rotation of the tool and/or a desired temperature) by the user. For example, a change of the locking of the lid from the locked position to the unlocked position represents an increase of the degree of freedom for the user, because the user thereby gets the possibility to remove the lid if required.

In one embodiment, the degree of freedom is increased or the number of permitted changes increases by the control releasing an additional desired value range for the user, in particular for the rotational speed of the mold, depending on the plurality of parameters, so that the user can request a desired value within the additional desired value range and this is implemented by the control. For example, the degree of freedom is increased if a user increases the rotational speed to a higher desired value within an additional desired value range permitted in this situation, when the lid is open which is not in the closed position, when the temperature of the food is correspondingly low and/or when the fill level is correspondingly low, instead of merely permitting a rigid, very low rotational speed or no rotational speed greater than zero of the tool when the lid is open.

The food processor may comprise various functional units, preferably the motor for rotating the tool and/or the heating element for heating.

The food processor comprises at least two devices for limiting a degree of freedom of a user, preferably including at least two locking devices, preferably a locking device for the locked connection of the food preparation vessel to a receptacle of the food processor and a locking device for a locked connection of the lid to the food preparation vessel. In one embodiment, the at least one device for limiting a degree of freedom of a user includes a checking unit that enables (releases) an increase in the degree of freedom or limits the degree of freedom based on the plurality of parameters and based on stored data. The checking unit is described in more detail below.

In one configuration, it is provided that the locking device for the food preparation vessel can assume a locked position and an unlocked position. In one configuration, it is provided that the locking device for the lid (of the food preparation vessel) can assume a locked position and an unlocked position. In one configuration, the locking device is configured for a coupled locking and unlocking of the food preparation vessel on or in a receptacle and its lid on the food preparation vessel such that the lid and the food preparation vessel assume the respective locked position or unlocked position either simultaneously or with a predefined time offset.

In an alternative or additional configuration, the control is configured such that during the food preparation process, the locking device for the lid can be in the unlocked position even though a rotational speed of the tool is in a rotational speed range between a minimum speed greater than zero and a maximum speed.

In an alternative or additional configuration, the control is configured such that during the food preparation process, the locking device for the food preparation vessel and/or its lid can be in the unlocked position even though a rotational speed of the tool is in a rotational speed range between a minimum speed greater than zero and a maximum speed.

In the locked position of the lid, the lid cannot be removed from the food preparation vessel by the user. In the locked position of the lid, the lid is in particular in the closed position on the food preparation vessel.

In the locked position of the food preparation vessel, the food preparation vessel cannot be removed from the receptacle of the food processor by the user. In particular, the receptacle is located on an upper side of the food processor housing.

In one embodiment, the locking device, for a coupled locking and unlocking of the food preparation vessel on or in the receptacle and its lid on the food preparation vessel, comprises mechanical components, in particular at least one lever, latch and/or Bowden cable, which mechanically interact with each other and mechanically couple the locking and/or unlocking of the lid and the food preparation vessel with each other. In particular, the locking device for coupled locking comprises a first locking means for the lid and a second locking means for the food preparation vessel and/or the locking device is configured such that a single actuation is sufficient to lock or unlock the lid and the food preparation vessel, respectively.

In one configuration, the food processor is configured such that the food preparation process is performed in recipe-assisted cooking mode based on a digital recipe with recipe steps for at least partially automated food preparation with the food processor or in manual cooking mode.

In manual cooking mode, the user himself influences the at least one functional unit via a user interface by a requested desired value such as operating a button to set a desired rotational speed of the tool or desired temperature of the heating element. In manual cooking mode, there is no influence from a digital recipe on the food preparation process.

In one embodiment, an accessory recognition is provided for recognizing and/or detecting the presence of a tool or accessory, the absence of a tool or accessory, the type of tool, and/or the type of accessory. Preferably, the accessory recognition is configured such that the detection and/or recognition is performed directly via integrated NFC tags, via a magnet-based system or by means of an electrically implemented system (e.g. resistance-based, capacitive or inductive). Alternatively or additionally, the accessory recognition is preferably configured such that detection and/or recognition is performed indirectly by confirmation by the user via the user interface and/or indirectly by means of optical detection (e.g., via camera). In one embodiment, the placing of an accessory or accessory part on the lid represents a parameter, preferably for activating the lock.

In one configuration, the plurality of parameters includes at least one actual state, in particular an actual value of the at least one functional unit, an actual state of the food and/or a further actual state of the food processor.

In one embodiment, a sensor for detecting an actual state (of the aforementioned actual states) and/or a determination unit (of the control) for determining the actual state is provided. An actual state may be an actual state property, such as an actual ingredient state. Preferably, the determination unit may comprise an algorithm for processing the measured values detected by the at least one sensor to determine the actual state.

A parameter that includes an actual state describes the food preparation process.

A parameter that contains an actual state in the form of an actual value of the at least one functional unit is preferably an actual rotational speed, an actual torque, an actual direction of rotation, an actual pressure and/or an actual heating power of the temperature element. In particular, the control can determine or output the actual rotational speed, the actual torque, the actual direction of rotation, the actual pressure and/or the actual heating power of the temperature element.

A parameter that contains an actual state of the food (in the food preparation vessel) is preferably an actual temperature of the food, an actual fill level of the food in the food preparation vessel, and/or an actual ingredient state of at least one ingredient of the food. Particularly preferably, an actual ingredient state includes a type of food (in particular one of several predefined types of food), a liquid fraction, a fat fraction, an oil fraction, a viscosity of the food and/or a fraction of chunky food (e.g. goulash). Preferably, it is provided to determine the current viscosity of the food by a signal evaluation of the motor current by which the motor is driven to rotate the tool. Alternatively or additionally, a recipe or recipe step may include information about the viscosity or for determining the viscosity. In particular, a temperature sensor is provided for measuring or determining (by the control based on the measured value of the temperature sensor) the actual temperature of the food. Preferably, a fill-level sensor is provided for detecting the actual fill level of the food in the food preparation vessel, or the control is configured such that the control determines the actual fill level based on measured values of at least one sensor, e.g. the weight sensors (preferably in combination with other measured values, information or data).

A so-called “further actual state of the food processor” includes in particular at least one actual state of the at least one device, preferably in the form of a setting state (e.g. of the locking device) and/or at least one actual state of a device state (preferably of the actual state of the lid position), an actual type of food preparation vessel, actual type of lid, actual type of tool and/or actual type of accessory.

In particular, the setting states comprise the locked state and the unlocked state. In particular, a setting state is detectable by a (respective) setting-state sensor, e.g. a lid-setting state sensor and/or food preparation vessel-setting state sensor. In particular, the lid positions comprise the closed position and not in closed position. In particular, the lid positions is detectable by a closing-position sensor. In one embodiment, the closing-position sensor can detect or determine when the user makes an unsuccessful attempt to remove the locked lid from the closed position due to the locked position. Preferably, a food preparation position is a device state with an actual state of the food preparation vessel position that can preferably be detected by a food preparation vessel position sensor. In particular, types of food preparation vessel comprise a first type of food preparation vessel having a larger fill volume and/or pressure vessel devices, compared to a second type of food preparation vessel having a smaller fill volume and/or no pressure vessel devices. In particular, a type of food preparation vessel sensor is provided to detect the type of food preparation vessel. Pressure vessel devices allow a pot to be used as a pressure cooker with a pressure greater than 1.1 bar. In particular, types of lid comprise a first type of lid e.g. having a lid opening and/or a second lid-type capable of tightly (airtightly) closing the food preparation vessel. In particular, a lid-type sensor is provided to detect the type of lid. In particular, types of tool comprise a first tool having cutting edges for chopping, a second tool having blunt elongated radial arms for stirring, and/or a third tool for scraping the bottom of the food preparation vessel. In particular, a tool-type sensor is provided for detecting the type of tool. In particular, types of accessory comprise a stirring attachment on the tool in particular having a butterfly-like shape comprising wings with openings, a measuring cup for placement on the lid or (over or) in a lid opening, a cooking basket insert for insertion into the food preparation vessel preferably having a cylindrical wall with openings, a container attachment for placing on the lid, in particular with openings on the underside for admitting steam from the food preparation vessel into the container attachment, a peeling disc with an abrasive surface and a central coupling interface for rotationally coupled placement on the tool for peeling vegetables including e.g. potatoes, and/or a cutting attachment for mounting on the food preparation vessel or lid comprising cutting means for cutting ingredients to be fed including vegetables, wherein the cutting means is rotationally coupled to the tool by a coupling mechanism.

In particular, an accessory-type sensor is provided for detecting a particular type of accessory or an accessory-type sensor is provided for each of the types of accessory for respectively detecting.

In one configuration, the plurality of parameters comprises at least a current desired value, a requested desired value and/or a planned desired state, in particular with respect to the at least one functional unit. Preferably, the current desired value, the requested desired value and/or the planned desired state relates to a desired rotational speed (of the tool and/or motor for rotating the tool), the desired torque (of the tool and/or motor), the desired direction of rotation (of the tool and/or motor), the desired pressure and/or desired temperature (of the heating element), a desired ingredient state of the food, and/or a desired mode of preparation.

“Requested” includes in particular requested by the user or a digital recipe, e.g. a requested desired value.

“Planned” particularly includes a planned (scheduled) desired state according to a digital recipe. In particular, a planned desired state is dependent on a planned cooking process such as sautéing, steaming or boiling.

“Current desired value” means the desired value that is currently being controlled (e.g., one of the at least one functional unit).

In one configuration, the plurality of parameters comprises at least one requested setting state of one of the at least one device or a (in particular current or planned) setting state of the at least one device, in particular regarding the locked position and unlocked position of the at least one locking device. In particular, the (current) setting state of one of the at least one device can be detected by the above-mentioned setting-state sensor.

In one embodiment, the plurality of parameters comprises at least one device state or a requested device state change. In particular, one of the plurality of parameters includes whether or not the lid is in the closed position. Preferably, the plurality of parameters comprises a requested change in the form of a requested unlocking and removal of the lid from the closed position, in particular based on a detection of the closing-position sensor described above. In particular, one of the plurality of parameters includes information about the type of food preparation vessel, the type of lid, the type of tool and/or the type of accessory and/or a presence or absence of the tool or an accessory. The information is preferably a planned state according to a recipe step.

In one configuration, the control is configured such that the control checks a requested change by means of stored data whether the requested change is permitted or not. The check is performed by the checking unit mentioned above, which releases an increase of the degree of freedom or restricts the degree of freedom on the basis of the plurality of parameters and the stored data. The requested change includes in particular a requested desired value for one of the at least one functional unit, a requested desired state, a requested setting state of one of the at least one device and/or a requested device state change. A parameter that includes a requested change may have an impact on the food preparation process. Thus, the requested change may involve requesting a new value (e.g., desired value) that is different from the current value (e.g., actual value). “Permitted” means that a criterion predefined in the stored data is met, so that the requested change is implemented by the control by controlling e.g. the corresponding functional unit. E.g. when the criterion is met, a user-requested rotational speed value is implemented by controlling the motor of the tool by a corresponding desired value to implement the requested rotational speed, so that the tool rotates with a new speed according to the requested rotational value. If the predefined criterion is not met, the functional unit is not driven as requested and the rotational speed remains unchanged (zero or greater than zero). Another example consists of the user attempting to remove the locked lid from the closed position during operation, thereby causing the corresponding change requests. If the check by the checking unit indicates that this change is permitted, the control will cause the locking device to change from the locked position to the unlocked position of the lid.

In one embodiment, the control is configured such that the control checks an actual state included in the plurality of parameters by means of stored data whether the actual state can be tolerated or not. The check is performed by the checking unit of the control, which releases an increase of the degree of freedom or limits the degree of freedom based on the plurality of parameters and using stored data. “Tolerated” means that a criterion predefined in the stored data is met, so that the control does not cause any action. If an actual state is not tolerated because a criterion predefined in the stored data is not met, the control initiates an action. Such an action may be, for example, changing a desired value of a functional component and/or outputting an indication to the user. For example, if the user attempts to remove the lid from the closed position, or the fill level has increased according to the present actual state, so that as a result a criterion predefined in the stored data is no longer met, in one embodiment this can cause the control to reduce the desired value of the rotational speed and/or the desired value of the torque of the tool. In particular, an action of the control is predefined in the stored data such that the predefined criterion is met. The user is thereby given additional freedom at the point desired by the user and a restriction is imposed elsewhere.

A check of a requested change is preferably done immediately. A check of the at least one actual state is preferably performed continuously (in particular with a cycle time of the control of less than one second) or in regular time intervals. In one embodiment with regular time intervals, the interval time is at most 30 seconds (to save computing capacity), preferably at most 2 seconds (to achieve increased cooking comfort). If a requested change is present, the corresponding check is performed in addition to and/or timed separately from the checks of the actual state.

In particular, the stored data, predefined criteria and/or results, optionally including partial results, are stored in a memory of the control, i.e., on a memory to which the checking unit of the control has access.

In one embodiment, the stored data is stored in the form of a decision tree that the checking unit uses for the check. In this way, the plurality of parameters can be logically assigned to a result as input values. Preferably, the decision tree is stored in the form of a decision algorithm.

In an alternative or additional embodiment, the stored data is stored in the form of a decision matrix that is used by the checking unit for the check. A decision matrix comprises a plurality of input variables or is a multi-dimensional table that assigns and outputs a result for each possible combination of the input values. Preferably, the decision matrix is a so-called lookup table. Alternatively or additionally the result can be determined with decision diagrams.

In particular, the decision tree and/or the decision matrix is configured for processing the plurality of parameters as input variables, preferably including the actual values and/or actual states of the at least one functional unit (rotational speed, torque, direction of rotation and/or heating power), position of the at least one locking device (locked position or unlocked position), lid position (in closed position or not), actual state of the food in the food preparation vessel (actual fill level and/or actual ingredient state, in particular including type of food, liquid content, fat content, oil content, viscosity and/or chunky food content), planned actual state (e. g. e.g., sautéed, cooked, kneaded, mixed, chopped, or boiled), planned cooking process (e.g., sautéing, cooking, boiling), and/or further actual states of the food processor (e.g., actual food-preparation-vessel type, actual type of lid, actual type of tool, or actual type of accessory).

In particular, the decision tree and/or the decision matrix is configured such that permitted and/or tolerated parameter ranges are provided. In particular, these permitted and/or tolerated parameter ranges are defined by the combination of at least five, preferably, at least ten, particularly preferably at least fifteen, and/or at most thirty parameters. For example, a rotational speed of 100 to 200 rpm can be permitted and tolerated if the fill level, the temperature, and the torque are within a specified range of values, preferably regardless of whether the lid is in the closed position or not. In this example, a parameter range was defined considering the combination of five parameters.

A result may include multiple partial results, e.g., whether a requested change is permitted or not, an actual state is judged tolerable or not, and/or a specification of an action (e.g., if a requested change is not permitted or an actual state is judged not tolerable).

In one embodiment, the stored data comprises a prioritization. In the embodiment of the decision tree, it can be defined by means of a prioritization that if two or more results or two equally ranked alternative partial results are determined by means of the input variables in the form of the plurality of parameters, one of the results is output as the only result.

In the embodiment of the decision matrix, a decision between two equally ranked results or partial results can be made by means of prioritization.

If, for example, the checking unit comes to the conclusion that an actual state is not tolerable and either the rotational speed of the tool is to be reduced or the lid is to be locked as a measure, it can be predefined by prioritization that a reduction of the rotational speed is always to be given priority and consequently the measure to be implemented by the control is the reduction of the rotational speed (to a desired value specified in the result).

In one embodiment, the stored data comprise multilevel decision levels, in particular differentiated according to a recipe-assisted cooking mode or according to a manual cooking mode. In this embodiment, two different lookup tables may be stored in a corresponding decision matrix, or two different decision algorithms may be stored in a corresponding decision tree.

In one configuration, the control is configured such that the control automatically controls the at least one functional unit and/or the at least one device for limiting a degree of freedom, in particular a locking device, in a modified manner according to the stored data and/or outputs an indication to the user if the check—by the checking unit—has shown that the actual state leaves or has left a permitted range.

In one embodiment, an indication (or the indication of the previous embodiment) is provided to the user by the stored data and/or is included in the stored data, preferably as a result or partial result. In particular, the indication is output to the user via an output unit, in particular by means of a display, a loudspeaker and/or a light means. Preferably, the indication includes textual information or a prompt to the user in textual or speech form or in the form of a light-up of at least one light means.

In one configuration, the control is configured such that the control controls the at least one functional unit in accordance with the requested change when the checking has determined that the requested change is permitted. In particular, the check is performed by the checking unit. The degree of freedom can be increased for the user in this way. For example, a requested increase in temperature is permitted with the tool rotating and a lid of the first type of lid having the lid opening even if the lid opening is not closed, but the fill level is low and the ingredient state indicates that the food will not burn at the requested desired temperature.

In one configuration, the control is configured such that the control controls the at least one device for limiting a degree of freedom, in particular a locking device, according to the requested change, if the checking has shown that the requested change can be permitted. In particular, the check is performed by the checking unit. The degree of freedom can be increased for the user in this way. For example, a requested change to remove the lid by unlocking the lid is permitted and the degree of freedom is thus increased if the check of the actual states based on the stored data permits this.

In one configuration, the control is configured such that the control controls the at least one functional unit and/or the at least one device for limiting a degree of freedom without the requested change if the check has determined that the requested change cannot be permitted. The degree of freedom of the user is thereby reduced (for example, because the requested change is not implemented) in order to maintain an overall higher degree of freedom of the user elsewhere. For example, a requested change in the form of a higher rotational speed requested by the user at the food processor is not implemented because e.g. the lid is not in closed position and based on the other parameters e.g. including temperature and/or fill level according to the stored data no higher rotational speed can be permitted in this situation to ensure a usual cooking comfort further on.

In one configuration, the control is configured such that the control outputs an indication to the user if the check has revealed that the requested change cannot be permitted. In this way, the user is informed that a requested change has not been implemented and in particular the reason for this is also output. In one embodiment, in cases where the usual cooking comfort with a food processor can still be met by the requested change, the requested change is implemented despite a negative check and the user is only given an indication of the negative result of the check. This gives the user the increased degree of freedom to change the requested change back or to continue the cooking process in an unchanged manner knowing the consequences. For example, a requested temperature increase by the user is implemented, but an indication is given that the food is likely to burn as a result.

In one embodiment, the control is configured such that the control controls the at least one functional unit and/or the at least one device for limiting a degree of freedom with a modified change that most closely matches the requested change according to the stored data and/or outputs an indication to the user when the check has determined that the requested change cannot be permitted.

For example, if the user requests a change in rotational speed to a specific high level (at, e.g., 3100 rpm) by operating a knob or icon on a touchscreen display accordingly, the control will control the rotational speed in a modified manner only to a lower level (at, e.g. 2000 rpm) than the requested, high level (at 3100 rpm) and optionally inform the user thereof by an indication if the modified changed level (at e.g. 2000 rpm) as the next rotational level to the requested change of the rotational level still meets the predefined criteria for permitting the requested change. In particular, the modified change is determined by the checking unit.

In one embodiment, the control is configured such that in recipe-assisted cooking mode, at the beginning of the food preparation process, all recipe steps of the digital recipe or only recipe steps with manual actions by the user are checked for requested or required setting states of the at least one device for limiting a degree of freedom and/or requested or required device state changes. Such changes thereof that limit the degree of freedom of the user and/or require a manual action by the user are collected. Such a manual action that also limits the user's degree of freedom is, in particular, a placing of the lid on the food preparation vessel performed by a user. This makes it possible to bring forward in particular all manual actions of the user, so that the user is not needed for manual actions for as long a period of time as possible. In other words, in this way it is possible to encourage to perform all the necessary actions that can be performed at the beginning and that cannot be automated, in order to allow the food processor to work independently for as long as possible. A reduction in the time that the user has to spend at the food processor for manual user interactions or actions is thus obtained.

The check is carried out in particular by the checking unit by means of the stored data.

In an alternative or additional embodiment, the control is configured such that in recipe-assisted cooking mode, at the beginning of each recipe step or each recipe step—in particular, each recipe step with at least one manual action by the user—the recipe step is checked for requested or required setting states of the at least one device for limiting a degree of freedom and/or requested or required device state changes. Such changes thereof that limit the degree of freedom of the user and/or require a manual action by the user, such as manually placing the lid on the food preparation vessel, are collected. Consequently, this is a step-by-step check by the checking unit. This allows manual actions by the user to be brought forward so that the user does not have to actively intervene for as long as possible.

Bringing forward a change that limits the user's degree of freedom is, for example, covering the food preparation vessel with the lid in the closed position. If it is only during the course of a recipe or recipe step that covering the food preparation vessel with the lid becomes necessary as a manual action by the user, a presence of the user is required until that time. According to the above described configurations, due to collecting these manual actions or changes, the user would be prompted to bring the lid into the closed position right at the beginning of the recipe or recipe step, so that the user is no longer needed at the above mentioned point in time, when this action is actually only required, because the lid has already been brought into the closed position at the beginning.

In one embodiment, the control is configured such that the control, in particular the checking unit of the control, determines the changes to be collected that limit the degree of freedom of the user and require manual action by the user using stored decision criteria.

Another aspect of the disclosure for solving the problem relates to a method for performing a food preparation process by heating, chopping and/or stirring a food in a food preparation vessel by means of a heating element for heating and/or a rotatable tool for chopping and/or stirring the food in the food preparation vessel. The food processor comprises at least one functional unit including a motor for rotating the tool and/or the heating element for heating. The food processor comprises at least one device for limiting a degree of freedom of a user during use of the food processor for a food preparation including at least one motor-driven locking device for the food preparation vessel or its lid. The method is characterized by the following steps: Controlling the at least one functional unit and the at least one device for limiting a degree of freedom based on a plurality of parameters that are able to describe or influence the food preparation process, such that a reduction or increase in the degree of freedom of the user during use of the food processor can be effected depending on the plurality of parameters.

The degree of freedom of the user may thereby be improved and/or increased during the preparation of a food with a food processor. The features, effects and configurations of the aspects of the disclosed device described above also apply to, and may be combined with, this aspect of the disclosure.

In one embodiment, an actual state and/or a requested change obtained in the plurality of parameters is received from a checking unit as input variables. In particular, a step of checking the received input variables follows, preferably by the checking unit, by means of stored data, whether or not the requested change can be permitted, and/or whether or not the actual state can be tolerated, in particular whether the actual state leaves or has left a permitted range.

If the actual state cannot be tolerated or leaves or has left a permitted range and/or if the requested change cannot be permitted, the method is continued as follows:
controlling the at least one functional unit and/or the at least one device for limiting a degree of freedom, in particular a locking device, on the basis of automatically modified changes according to the stored data, and/or
outputting an indication to the user according to the stored data.

In particular, a maximum rotational speed of the tool allowed by the checking unit in conjunction with the stored data is 400 revolutions per minute when the lid is not in the closed position.

In particular, the maximum current permitted by the checking unit in conjunction with the stored data to supply the motor for rotating the tool is preferably 0.8 A or 1 A when the lid is not in the closed position. The torque of the tool can be limited in this way particularly effectively, for example to 0.5 N*m, so that cooking can be permitted by the checking unit even with the lid open and the tool rotating, in particular by a modified activation of the motor by the control. The usual cooking comfort when cooking with a food processor can be ensured in this way.

A further aspect of the disclosure relates to a computer program comprising instructions which, when the program is executed by the control, cause the control to perform the method described above.

A further aspect of the disclosure for solving the problem relates to a food processor for performing a food preparation process by heating, chopping and/or stirring a food in a food preparation vessel by means of a heating element for heating and a rotatable tool for chopping and/or stirring the food in the food preparation vessel, wherein the food processor includes a locking device for a lid that, in a locked position, locks the lid in a closed position on the food preparation vessel and, in an unlocked position, unlocks the lid so that the lid can be removed from the food preparation vessel by the user to open the food preparation vessel. In this aspect of the disclosure, the food processor is configured such that during the food preparation process, the locking device for the lid assumes the unlocked position when an actual rotational speed of the tool is within a rotational speed range between a minimum speed greater than zero and a maximum speed. The degree of freedom of the user can thereby be increased in an improved manner during the preparation of a food with a food processor. The rotational speed range is defined in particular in stored data. In one embodiment, the control is configured such that the lid is in the unlocked position, or the lid is unlocked when the tool rotates in a specific rotational speed range or a specific rotational speed range is requested by a recipe step or the user (via the user interface of the food processor). The features, effects and configurations of the aspects of the device described herein also apply to, and may be combined with, this aspect of the device.

When an actual state is changed (e.g. lid suddenly no longer in the closed position or the temperature has dropped abruptly) or at a requested desired state (e.g. rotational speed, temperature or direction of rotation inputted by the user), a check is performed with regard to the device settings and parameter ranges dependent on this. If the check shows that a different device setting is required due to the change of the actual state in order to ensure the usual cooking comfort, the device setting is changed accordingly. If the check indicates that a different device setting is required by a requested desired state, a corresponding change of the device setting is made and preferably an indication of permitted desired ranges or changes of the device settings to be implemented by the user, which would make the requested change permissible (e.g. bringing the lid into the closed position). In particular, at least one device setting and/or at least one parameter range is dependent on an actual state or requested desired state.

In one embodiment, the food processor comprises at least one sensor for detecting at least one parameter of a plurality of parameters of the food processor and the food preparation process, wherein the food processor comprises at least one check unit for ensuring cooking comfort for the user during food preparation with the food processor and activating at least one security device for this purpose, for example a locking device for locking a component so that a user's ability to access the food is restricted. In this embodiment, the food processor is further configured such that the check unit deactivates at least one of the at least one safety device during a food preparation process in response to at least one of the plurality of parameters. In one embodiment, the plurality of parameters includes an actual state reflecting a pressure in the food preparation vessel.

In one embodiment, a digital recipe is checked by the control by the check unit by means of the stored data, in particular taking into account an ingredient category (including information on a fat or oil content) based on the digital recipe and/or based on an ingredient analysis by at least one sensor, in order to implement the maximum degree of freedom for the user (i.e. minimum possible safety devices). In particular, a locking device can serve as a safety device. In particular, an activation of a locking device as a safety device can be defined by a recipe step, preferably individually for each recipe step.

In one embodiment, at the beginning of a food preparation process, in particular in the manual cooking mode, all safety devices including the at least one locking device are activated only as little and as low as possible so that the user has a maximum possibility of access to the food, wherein in the course of the food preparation process, depending on a check by the check unit, one or more further safety devices are to be activated if necessary and the possibility of access of the user to the food is thereby reduced. If in the further course of the food preparation process, depending on the check by the check unit, a reduction of the activated safety devices becomes possible, this is done so that the degree of freedom of the user is continuously reduced and increased, but maximized overall. In this way, for example, a delay time, also called dead time, can be avoided for the user during a change from a locked position to an unlocked position, if the unlocked position already occurs at the earliest possible time when the user has not yet even attempted to open the lid.

In one embodiment, preferably in recipe-assisted cooking mode, all necessary safety devices are activated at the beginning, and successively deactivated and reduced after the start of the cooking process depending on the check by the check unit and/or—if possible—before the end of the cooking process of a recipe step.

In one embodiment, a device for limiting a degree of freedom of a user comprises a safety device. In particular, a safety device can be implemented by the check unit by not permitting or tolerating critical ranges of parameter combinations.

The present disclosure allows to permit cooking parameter ranges and/or to activate and/or deactivate devices (in particular safety devices), such as the at least one locking device, depending on the type of use. In simple terms, the user specifies or requests what he wants, and the food processor tries to implement this and controls the functional unit and/or device accordingly as necessary for this purpose. It is ensured that desired values (e.g. direction of rotation, torque, rotational speed, heating power) are permitted, which in the respective operating state enable usual cooking comfort and at the same time enable the user to be able to remove the lid quickly, to be able to remove the food preparation vessel quickly, to be able to select the direction of rotation freely, to be able to select the rotational speed freely and/or to be able to select the desired temperature freely or within limited ranges.

In particular, the control system always aims for a state that is “as open as possible”, allowing the fastest possible access to the food in the food preparation vessel or the cooking process.

In particular, the motor supports different rotational directions (clockwise, counterclockwise), different rotational speeds and/or different torques. In particular, an integrated and/or adjustable heating element with different temperature ranges is provided.

In one embodiment, an adaptation is either event-controlled or use-dependent, in particular taking into account an identified use scenario, which is preferably detected by a check of the plurality of parameters.

In the event-controlled embodiment, a lid position (lid not present, lid in closed position, lid locked) is detected and, depending on this, a preselection of the permitted or tolerated rotational speed, direction of rotation and/or the set temperature is defined (in the stored data).

In the use-dependent embodiment, recipe specifications and/or the check can be implemented by the check unit in the ongoing food preparation process, in particular as indicated in the following examples. For example, recipes may be assigned to predefined recipe clusters that serve as indicators (or are included in the stored data) of what can be permitted/tolerated. In particular, recipes with large amounts of liquid that are heated >95° C. are required to have the lid in closed position. In particular, the lid in locked-state is required for recipes with large liquid portions, large absolute amounts of liquid, which are stirred/pureed with large rotational speeds. In particular, for recipes without fat or oil, in which high temperatures are used and the tool stands still (rotational speed equal to zero), an open lid is also permitted or tolerated, i.e., not in the closed position.

In particular, an open lid is permitted or tolerated if a certain type of food preparation vessel has been detected in the receptacle, which can be assigned to a predefined type with a particular size, and the rotational speed is zero.

In one embodiment, machine parameters of the control and/or the food processor are used as parameters or to determine parameters for the plurality of parameters, in particular as an indicator, preferably as an actual state or actual value for a quantity of food added or in the food preparation vessel, a viscosity of an ingredient or the food (in particular determined on the basis of the motor current for rotating the tool), and/or a chunkiness of an ingredient or the food (e.g. for goulash). Preferably, the chunkiness can be determined based on the motor current peak or on a rapid temperature change at the temperature sensor (e.g., when a cold piece falls on the temperature sensor after a discontinuous stirring step) or on a center of gravity shift of the entire food processor or an imbalance, which may be detected by the weight sensors in the stand feet. If chunky food (and not liquid) is detected, the lid can be unlocked. In particular, a further actual state or actual value is a determined heating speed in relation to the heating power used, in order to infer the heat capacity and, via this, the food (because liquid or low-viscosity foodstuffs and foods and, thus, foodstuffs and foods that tend to splatter have a lower specific heating speed on average than higher-viscosity foodstuffs or foods with the same heating power). Thus, this criterion can preferably be used in the check whether or not a lid in closed position is necessary. In particular, the food preparation process can be started with a locked lid and then, taking into account the actual viscosity during the check, the lid can be unlocked by the check unit and locked again if necessary.

In particular, a greater rotational speed may be permitted and/or tolerated in a food preparation vessel of the larger type than in a smaller type. For example, certain functions or parameter ranges may be permitted and/or tolerated in a first type of tool for stirring that are not permitted and/or not tolerated in another type of tool for cutting.

In particular, at least three, five or all of the following parameters are particularly relevant in the check: rotational speed, temperature, pressure, filling quantity, type of accessory, type of foodstuff, mode of preparation.

In one embodiment, one or more safety devices are selected according to the check of the plurality of parameters and controlled for activation, in particular under assignment to a classification for reducing the amount of stored data.

In one embodiment, the necessity of the presence of the lid in the closed position and/or the necessity of the locked position of the lid and/or the food preparation vessel is differentiated in multiple levels, preferably for the implementation of a decision tree with a reduced amount of data. In particular, for this purpose, a distinction is first made in a first decision level as to whether cooking is performed in manual cooking mode or recipe-assisted cooking mode. For example, in recipe-assisted cooking mode, the lid is required in the closed position and/or in manual cooking mode, the lid can remain away from the closed position. Preferably, a second decision level is provided that performs the check for allowability and/or tolerability based on the rotational speed. In particular, a third decision level is provided that differentiates between event-controlled and use-dependent adjustment.

In one embodiment, additional parameter ranges of the cooking parameters are released as a function of at least one locking state to increase the degree of freedom of the user. If, for example, a rotational speed above a speed limit for locking the lid defined in the stored data is requested by the user (or by the recipe step), this is only implemented by the control if the lid is in the closed position and additionally locked so that it cannot be opened manually. It is also ensured that manual opening of the lid is only possible again when the tool has fallen below a certain rotational-speed limit. Preferably, an additional waiting time can be defined that must elapse before the lid can be opened again. This ensures that the movements of the tool and the food in the food preparation vessel have decayed. In particular, a sensor or sensors are provided that can detect whether a lid is resting on the food preparation vessel in the closed position (in an unlocked manner) and/or whether a lid is resting on the food preparation vessel in the closed position and is locked at the same time.

In one embodiment, a rotational speed control is provided for the motor of the tool, wherein the rotational speed is monitored and an action is taken when the locking rotational speed limit is exceeded if the lid is not locked. In particular, a limit of the direction of rotation and/or a torque limit is provided when the tool is rotating without a lid in the closed position.

It may happen that the tool is operated at low rotational speed and the conditions for an unlocked lid are met, but the user still wants to lock the lid, e.g. to prevent it from being lifted by steam or moving ingredients. In one embodiment, for this case, a means for activating the locking mechanism by the user is provided, for example by operating a corresponding button or by manually operating a mechanical locking mechanism. Alternatively or additionally, it is also possible to force locking of the lid when required (corresponding presets for all operating conditions).

In one embodiment of the use-dependent adaptation, the food processor is configured in particular such that the food preparation process is started preferably with maximum safety precautions for the current use case. Preferably, based on an analysis of the digital recipe or recipe step (e.g., by the maximum rotational speed or maximum temperature to be used), the required safety precaution (e.g., locked position of the lid and/or food preparation vessel) is specified for the entire food preparation process or only for one or more recipe steps. In particular, a next step may be provided in which the required safety precautions are reduced by the check of the plurality of parameters (by the check unit). For example, several recipe steps can be processed in a sequence, wherein the lid in closed position is only required in one last step (but not in all other recipe steps). This would then be requested at the first recipe step so that the cooking steps can be performed without interruption.

The solution of the present disclosure thus makes it possible to identify usage scenarios and to activate or deactivate safety devices depending on them. Activation of a safety device means a change to a position or state that reduces the user's degree of freedom (and in particular his or her access to the food), e.g. a locking of a lid or food preparation vessel. Depending on requested desired values (in particular e.g. rotational speed, temperature) it is decided on the basis of the check using the stored data whether the lid must be in closed position and/or locked. If the criteria are met, the process step is started with the requested desired values. Otherwise, the user is informed by means of an output indication that e.g. the lid must be put on. If the user does not place the lid after the indication (i.e., in closed position), the recipe step can be performed with modified desired values, which are limited compared to the required values, if other criteria are met. For example, if the lid is placed (in closed position) during an ongoing recipe step, but not locked because the rotational speed permits it, and the lid is then spontaneously detached by the user, this is detected and the torque (and in particular also the rotational speed) is adjusted so that the user can continue cooking with the usual cooking comfort. In recipe-assisted cooking mode, also called Guided Cooking, the required operating states (lid in closed position, lid locked by locked position, and/or food preparation vessel locked by locked position) are determined depending on the planned or required desired values of the digital recipe or recipe steps. The user is informed via an indication whether the lid must be put on. For special process steps, it may also be necessary not to put the lid on (in closed position), e.g. to allow steam to flow out unhindered. In these cases, the user is prompted to remove the lid.

Identifying a usage scenario and automatically adjusting operating conditions that enable cooking with the food processor with usual cooking comfort is thus enabled, and more efficient cooking and handling is enabled by the adaptive device behavior depending on the usage scenario.

### LIST OF REFERENCE SIGNS

1 Food processor
2 Food preparation vessel
3 Lid
4 Touch screen display
5 Knob
6 Heating element
7 Closing-position sensor
8 Weight sensor
9 Tool
10 Control
11 Motor
12 Lid opening
13 Icon
14 Output unit
15 Checking unit
16 First input variable
17 Second input variable
18 Measure
19 Indication
20 Food
21 Processor
22 Memory
23 Locking device for the lid
24 Locking movement
25 Locking device for the food preparation vessel
26 Accessory
27 Housing
28 Temperature sensor
29 Receptacle
30 Base

1. A food processor for performing a food preparation process by heating, chopping and/or stirring a food, the food processor comprising
a food preparation vessel,
at least one of a heating element for heating and a rotatable tool for chopping and/or stirring the food in the food preparation vessel,
at least one functional unit including a motor for rotating the tool and/or the heating element for heating,
at least one device for limiting a degree of freedom of a user during use of the food processor for food preparation including at least one motor-driven locking device for the food preparation vessel or its lid, and
a control of the food processor configured such that the control, based on a plurality of parameters that are able to describe or influence the food preparation process, controls the at least one functional unit and the at least one device for limiting the degree of freedom such that a reduction or an increase of the user's degree of freedom during the use of the food processor can be effected in dependence on the plurality of the parameters.

2. The food processor of claim 1, wherein the locking device for the food preparation vessel and/or its lid assumes a locked position and an unlocked position, wherein the control is configured such that during the food preparation process the locking devices in the unlocked position although a rotational speed of the tool lies in a rotational speed range between a minimum rotational speed greater than zero and a maximum rotational speed.

3. The food processor of claim 1, wherein the food processor is configured such that the food preparation process is carried out in recipe-assisted cooking mode on the basis of a digital recipe with recipe steps for at least partially automated food preparation with the food processor, or in manual cooking mode.

4. The food processor of claim 1, wherein the plurality of parameters include at least one actual state, in particular an actual value of the at least one functional unit, an actual state of the food and/or a further actual state of the food processor.

5. The food processor of claim 1, wherein the plurality of parameters comprises at least a current desired value, a requested desired value and/or a planned desired state, in particular with respect to the at least one functional unit, preferably including a desired rotational speed, a desired torque, a desired direction of rotation, a desired temperature, a desired pressure, a desired ingredient state of the food, and/or a desired mode of preparation.

6. The food processor of claim 1, wherein the plurality of parameters comprises at least one requested setting state of one of the at least one device or a setting state of the at least one device, in particular with respect to the locked position and unlocked position of the at least one locking device.

7. The food processor of claim 1, wherein the plurality of parameters comprises at least one device state or a requested device state change, in particular with respect to an attached or detached lid position, with respect to a type of food preparation vessel, a type of lid, a type of tool, an type of accessory and/or a presence of the tool or an accessory.

8. The food processor of claim 1, wherein the control is configured such that the control checks a requested change or an actual state included in the plurality of parameters by means of stored data whether or not the requested change can be permitted and/or the actual state can be tolerated.

9. The food processor of claim 8, wherein the control is configured such that the control automatically controls the at least one functional unit and/or the at least one device for limiting the degree of freedom in a modified manner according to the stored data and/or outputs an indication to the user if the check has shown that the actual state leaves or has left a permitted range.

10. The food processor of claim 8, wherein the control is configured such that the control controls the at least one functional unit and/or the at least one device for limiting the degree of freedom according to the requested change, if the check has shown that the requested change can be permitted.

11. The food processor of claim 9, wherein the control is configured such that the control controls the at least one functional unit and/or the at least one device for limiting the degree of freedom according to the requested change, if the check has shown that the requested change can be permitted.

12. The food processor of claim 8, wherein the control is configured such that the control controls the at least one functional unit and/or the at least one device for limiting a degree of freedom without the requested change and/or outputs an indication to the user if the check has shown that the requested change cannot be permitted.

13. The food processor of claim 9, wherein the control is configured such that the control controls the at least one functional unit and/or the at least one device for limiting a degree of freedom without the requested change and/or outputs an indication to the user if the check has shown that the requested change cannot be permitted.

14. The food processor of claim 10, wherein the control is configured such that the control controls the at least one functional unit and/or the at least one device for limiting a degree of freedom without the requested change and/or outputs an indication to the user if the check has shown that the requested change cannot be permitted.

15. The food processor of claim 8, wherein the control is configured such that the control controls the at least one functional unit and/or the at least one device for limiting a degree of freedom with a modified change that comes closest to the requested change according to the stored data and/or outputs an indication to the user if the check has shown that the requested change cannot be permitted.

16. The food processor of claim 9, wherein the control is configured such that the control controls the at least one functional unit and/or the at least one device for limiting a degree of freedom with a modified change that comes closest to the requested change according to the stored data and/or outputs an indication to the user if the check has shown that the requested change cannot be permitted.

17. The food processor of claim 10, wherein the control is configured such that the control controls the at least one functional unit and/or the at least one device for limiting a degree of freedom with a modified change that comes closest to the requested change according to the stored data and/or outputs an indication to the user if the check has shown that the requested change cannot be permitted.

18. The food processor of claim 3, wherein the control is configured such that, in recipe-assisted cooking mode, at the beginning of the food preparation process, all recipe steps of the digital recipe or at the beginning of a recipe step, in particular a recipe step with manual actions by the user, are checked for requested or required setting states of the at least one device for limiting a degree of freedom and/or requested or required device state changes, and such changes thereof are collected that limit the degree of freedom of the user and require a manual action of the user, in particular a placing of the lid onto the food preparation vessel.

19. A method for performing a food preparation process by heating, chopping and/or stirring a food in a food preparation vessel by means of a heating element for heating and/or a rotatable tool for chopping and/or stirring the food in the food preparation vessel, wherein the food processor comprises at least one functional unit including a motor for rotating the tool and/or the heating element for heating, wherein the food processor comprises at least one device for limiting a degree of freedom of a user during use of the food processor for food preparation including at least one motor-driven locking device for the food preparation vessel or its lid,
the method including the following steps:
controlling the at least one functional unit and the at least one device for limiting a degree of freedom based on a plurality of parameters that are able to describe or influence the food preparation process, such that a reduction or increase of the user's degree of freedom during use of the food processor can be effected in dependence on the plurality of parameters.

20. A computer program comprising instructions which, when the program is executed by the control, cause the control to carry out the method according to the preceding claim.
